(19) United States
(12) Patent Application Publication
(10) Pub. No.: US 2025/0324016 A1
(43) Pub. Date: Oct. 16, 2025

(54) COILED CONNECTING CABLE FOR RECORDING DEVICES

(71) Applicant: Axon Enterprise, Inc., Scottsdale, AZ (US)

(72) Inventors: Nache D. Shekarri, Scottsdale, AZ (US); Hans Moritz, Scottsdale, AZ (US); Zackary T. Hickman, Austin, TX (US); Kyle A. Wilson, Glendale, AZ (US); Eric W. Brettner, Laveen, AZ (US)

(21) Appl. No.: 19/176,310

(22) Filed: Apr. 11, 2025

Related U.S. Application Data
(60) Provisional application No. 63/632,903, filed on Apr. 11, 2024.

(51) Int. Cl. H04N 5/77; H04N 7/10; H04N 7/22

(52) U.S. Cl. CPC H04N 5/77; H04N 7/10; H04N 7/22

(57) ABSTRACT

A recording system may comprise a primary recording device and an auxiliary recording device. A connecting cable may be used to couple the primary recording device to the auxiliary recording device. The connecting cable may be configured to provide electrical power and/or data transmission between the primary recording device and the auxiliary recording device. The connecting cable may be configured to allow the primary recording device to provide electrical power and transmit data instructions to the auxiliary recording device. The connecting cable may be configured to allow the auxiliary recording device to transmit raw data to the primary recording device, via an optical fiber channel. The connecting cable may comprise a coiled portion. The coiled portion may be configured to translate from a first position to a second position.

### FIELD OF THE INVENTION

Embodiments of the present disclosure relate to a coiled connecting cable for recording devices.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1A depicts a recording system, in accordance with various embodiments;

FIG. 1B depicts a recording system mounted at various positions on a user, in accordance with various embodiments;

FIG. 1C depicts a recording system mounted at various positions on a user, in accordance with various embodiments;

FIG. 2A is a perspective view of a connecting cable, in accordance with various embodiments;

FIG. 2B is a perspective view depicting internal layers of a connecting cable, in accordance with various embodiments;

FIG. 2C is a cross-sectional view of a connecting cable, in accordance with various embodiments;

FIG. 3 is a perspective view of a connecting cable with a stretch limiting bracket, in accordance with various embodiments; and

FIG. 4 is a block diagram illustrating components of a computer-based system, in accordance with various embodiments.

Elements and steps in the figures are illustrated for simplicity and clarity and have not necessarily been rendered according to any particular sequence. For example, steps that may be performed concurrently, in different order, or omitted are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. In some embodiments, one or more steps recited in any of the method or process descriptions may be omitted. Any reference herein to singular includes plural embodiments, and any reference to more than one component or step may include a singular embodiment or step. Reference to attached, fixed, coupled, connected, or the like may include permanent, removable, temporary, partial, full, and/or any other possible attachment option. Surface shading lines may be used throughout the figures to denote different parts but not necessarily to denote the same or different materials.

In various embodiments, an incident (or similar terms and phrases, such as an emergency) may refer to human or animal activities and to a period of time while these activities take place. Incidents include, for example, formation of agreements, transactions, negotiations, discussions, ceremonies, meetings, medical procedures, sporting events, crimes, attempted crimes, disagreements, assaults, conflicts, discoveries, research, investigations, surveillance, civil torts, and/or the like. Incidents may include consequences including changes to property such as improvements, repairs, construction, production, manufacture, growth, harvesting, damage, loss, theft, burglary, arson, goods damaged in shipment, conditions of real estate, conditions of agricultural and forestry property, and/or the like. An incident may include damage to property, injury to persons or animals, and/or the like. Damage to property or injury to persons or animals may be accidental or brought on by the action or failure to act of one or more persons. Incidents may include information that may be valuable or otherwise important, helpful, or needed for risk management, insurance, claims, achievements, sports records, news reporting, entertainment, criminal proceedings, civil proceedings, and/or the like.

One or more incident responders may respond or help before, during, or after an incident. For example, in response to an incident including a fire (e.g., burning building, house fire, etc.), incident responders may typically include a law enforcement officer, a firefighter, a medical responder (e.g., an emergency medical technician (EMT), a paramedic, an ambulance technician, etc.), and/or the like. As a further example, in response to an incident including a crime or attempted crime, incident responders may include one or more law enforcement officers, security, and/or the like.

Information (e.g., data, audio, visual, location, environmental, etc.) gathered about an incident may describe the incident. Information may include facts about the activities of the incident, consequences of the incident, time of the incident, location of the incident, identity of humans, animals, or objects related to the incident, and/or the like. Information about an incident may include or form a report of an incident (e.g., an incident report). Information about the incident may be gathered before, during, or after an incident. Incident information may be recorded (e.g., data, audio, video, etc.) to document an incident before, during, or after a time of occurrence of the incident.

Recording incident information may capture at least some of the information about the incident. Recording may further protect against loss of information, for example, by physical loss, human memory, and/or the like. For example, incident responders may capture audio and/or visual information of the incident. The audio and/or visual information may be captured by an incident recording device, such as, for example, a body-worn camera, a smart phone or internet of things (IoT) device, a vehicle-mounted camera, a surveillance camera, and/or any other recording device discussed herein.

In various embodiments, a recording system may be configured to capture incident information. The recording system may be configured to selectively capture incident information from a plurality of vantage points. For example, the recording system may be configured to capture incident information from a fixed field of view and a visual point of view configured to at least partially align with a point of view of the incident responder. In various embodiments, and as discussed further herein, the recording system may be configured to provide a plurality of interconnected recording devices, each recording device configured to capture incident information at a different vantage point.

In various embodiments, a recording system may comprise a first housing and a second housing. The first housing may include a first recording device (e.g., an auxiliary recording device). The second housing may include a second recording device (e.g., a primary recording device). The first housing may capture incident information independent of the second housing. The second housing may capture incident information independent of the first housing. The first housing and the second housing may cooperate to capture incident information. The second housing may instruct the first housing to capture incident information. The first housing may transmit incident information to the second housing.

The first housing may capture a first image and the second housing may capture a second image. The first image may contain a first captured data and the second image may contain a second captured data. The first captured data may be at least partially the same as the second captured data (e.g., the first image and the second image may each capture the same incident information from different points of view, the first image may at least partially visually overlap with the second image, etc.). The first captured data may be at least partially different than the second captured data (e.g., the first image may capture incident information that the second image did not capture, the second image may capture incident information that the first image did not capture, etc.).

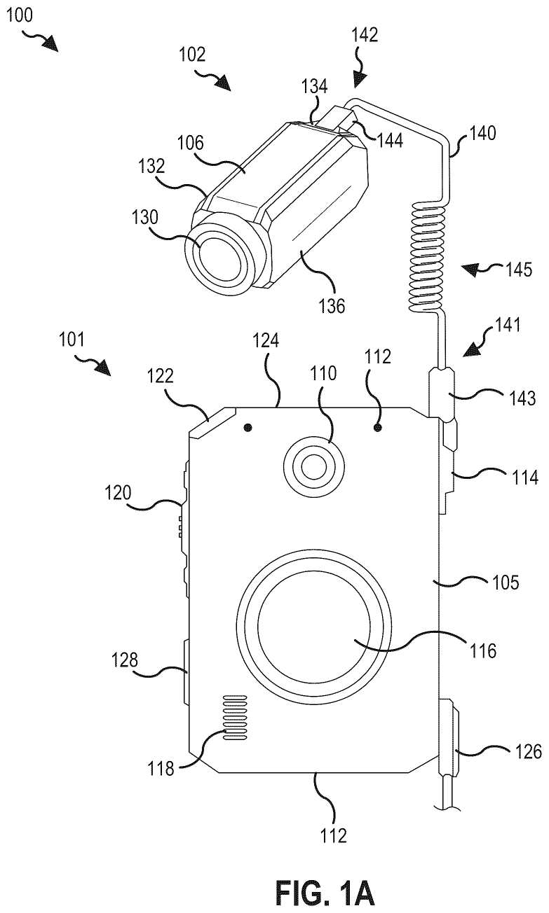

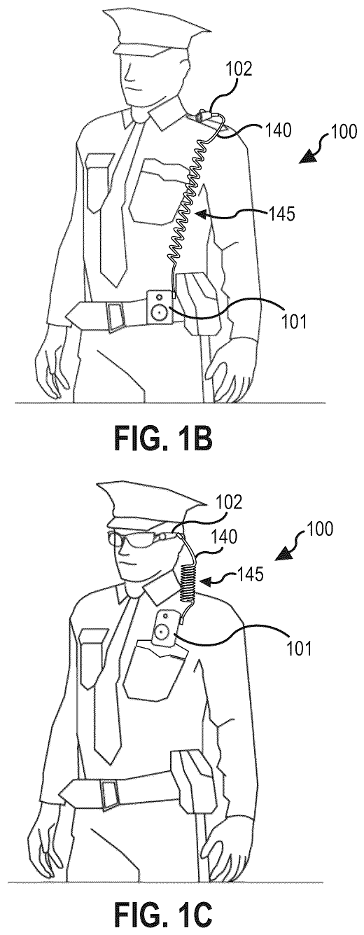

In various embodiments, and with reference to FIGS. 1A-1C, a recording system 100 is disclosed. Recording system 100 may be similar to any other recording system disclosed herein. Recording system 100 may comprise a primary recording device 101 and an auxiliary recording device 102. In some embodiments, recording system 100 may comprise any other number of recording devices.

In various embodiments, primary recording device 101 (e.g., a second housing, a first recording device, a body-worn recording device, a processing recording device, etc.) may comprise any suitable device configured to capture incident information. For example, primary recording device 101 may comprise a body-worn camera, a smart phone, a computer-based system, and/or the like.

Primary recording device 101 may comprise a body 105 (e.g., a primary recording device body, a primary recording device housing, etc.) defining an outer surface of primary recording device 101. Body 105 may comprise a front surface opposite a back surface. Body 105 may comprise a top surface opposite a bottom surface. Body 105 may comprise a first side surface (e.g., a left side surface) opposite a second side surface (e.g., a right side surface).

Body 105 may comprise mechanical features configured to couple primary recording device 101 to a surface. Body 105 may be configured to couple (e.g., mount) to a user. For example, the mechanical features may be configured to interface with an article of clothing or a mount assembly on a user. Body 105 may mount to a location on the user (e.g., a primary mount location, a primary location, etc.). For example, body 105 may mount to a belt mount, a chest mount, a shoulder mount, and/or the like on the user. In response to being mounted to the location on the user, primary recording device 101 may be positioned to capture incident information at a fixed position relative to the user. In other embodiments, body 105 may also be configured to mount on or in a vehicle or similar platform.

In various embodiments, primary recording device 101 may comprise one or more of an image capturing system 110, an audio capturing system 112, an auxiliary connection port 114, a user interface 116, an audio output system 118, an audio output volume control 120, a communications interface 122, a display 124, a power charging port 126, a power switch 128, and/or the like. In various embodiments, primary recording device 101 may also comprise one or more of a processor, a memory, a network interface, a power supply, and/or the like.

In various embodiments, body 105 may be configured to house (fully and/or at least partially) various mechanical, electrical, and/or electronic components configured to aid in performing the functions of primary recording device 101. For example, and in accordance with various embodiments, body 105 may be configured to house (fully and/or at least partially) image capturing system 110, audio capturing system 112, and/or auxiliary connection port 114. As a further example, and in accordance with various embodiments, body 105 may be configured to house (fully and/or at least partially) user interface 116, audio output system 118, audio output volume control 120, communications interface 122, display 124, power charging port 126, power switch 128, and/or the like. As a further example, and in accordance with various embodiments, body 105 may be configured to house various internal electronic components such as a processor, a memory, a network interface, a power supply, and/or the like.

In various embodiments, the processor may comprise any circuitry, electrical components, electronic components, software, and/or the like configured to perform various operations and functions discussed herein. For example, the processor may comprise a processing circuit, a processor, a digital signal processor, a microcontroller, a microprocessor, an application specific integrated circuit (ASIC), a programmable logic device, logic circuitry, state machines, MEMS devices, signal conditioning circuitry, communication circuitry, a computer, a computer-based system, a radio, a network appliance, a data bus, an address bus, and/or any combination thereof. In various embodiments, the processor may include passive electronic devices (e.g., resistors, capacitors, inductors, etc.) and/or active electronic devices (e.g., op amps, comparators, analog-to-digital converters, digital-to-analog converters, programmable logic, SRCs, transistors, etc.). In various embodiments, the processor may include data buses, output ports, input ports, timers, memory, arithmetic units, and/or the like.

The processor may be configured to provide and/or receive electrical signals whether digital and/or analog in form. The processor may provide and/or receive digital information via a data bus using any protocol. The processor may receive information, manipulate the received information, and provide the manipulated information. The processor may store information and retrieve stored information. Information received, stored, and/or manipulated by the processor may be used to perform a function, control a function, and/or to perform an operation or execute a stored program.

The processor may control the operation and/or function of other circuits and/or components of primary recording device 101. The processor may receive status information regarding the operation of other components, perform calculations with respect to the status information, and provide commands (e.g., instructions) to one or more other components. The processor may command another component to start operation, continue operation, alter operation, suspend operation, cease operation, or the like. Commands and/or status may be communicated between the processor and other circuits and/or components via any type of bus (e.g., SPI bus) including any type of data/address bus.

In various embodiments, the processor may be in electrical, electronic, and/or mechanical communication with one or more components of primary recording device 101. For example, the processor may be in communication with the memory, the network interface, the power supply, image capturing system 110, audio capturing system 112, user interface 116, audio output system 118, audio output volume control 120, communications interface 122, display 124, power switch 128, and/or the like.

In various embodiments, the memory may comprise one or more memory, data structures, or the like configured to store data, programs, and/or instructions. The memory may be in electrical and/or electronic communication with the processor, the network interface, image capturing system 110, audio capturing system 112, and/or any other suitable component of the recording device.

In an embodiment, the memory may comprise a tangible, non-transitory computer-readable memory. Instructions stored on the tangible non-transitory memory may allow the processor to perform various operations, functions, and/or steps, as described herein. For example, in response to the processor executing the instructions on the tangible non-transitory memory, the processor may communicate with image capturing system 110 and/or audio capturing system 112 to capture image and/or audio data, end capturing of the image and/or audio data, and/or the like, as discussed further herein. As a further example, in response to the processor executing the instructions on the tangible non-transitory memory, the processor may communicate with an auxiliary recording device (e.g., auxiliary recording device 102), via the network interface and/or auxiliary connection port 114, to capture image and/or audio data, end capturing of the image and/or audio data, and/or the like, as discussed further herein. The processor may execute the instructions in response to operation of user interface 116, as discussed further herein. In an embodiment, the memory may also be configured to receive, store, and maintain incident recordings, including captured image and audio data. In that regard, the memory may include a storage medium, data structure, database, memory unit, hard-disk drive (HDD), solid state drive (SSD), removable memory, and/or the like.

In various embodiments, the network interface may be configured to enable the transmission and/or reception of data between primary recording device 101 and one or more additional devices, servers, networks, or the like. For example, in some embodiments, the network interface may be configured to enable the transmission and/or reception of data between primary recording device 101 and an auxiliary recording device (e.g., directly or via auxiliary connection port 114). The network interface may be in electric and/or electronic communication with the processor and/or the memory. The network interface may comprise one or more suitable hardware and/or software components capable of enabling the transmission and/or reception of data, such as, for example, a communications unit, a transmitter, and/or a receiver as discussed further herein. In various embodiments, primary recording device 101 may only have a receiver configured to receive data (e.g., images, video, etc.) from an auxiliary recording device. In various embodiments, primary recording device 101 may have a transmitter and a receiver to transmit data (e.g., instructions) to and receive data (e.g., images, video, etc.) from an auxiliary recording device.

In various embodiments, the power supply (e.g., power source) may be configured to provide power to one or more electric and/or electronic components of the recording device. In various embodiments, the power supply may also be configured to provide power to an auxiliary recording device, such as, for example, via auxiliary connection port 114. The power supply may provide energy for operating electronic and/or electrical components (e.g., parts, subsystems, circuits, etc.). The power supply may provide electrical power. The power supply may include a battery. The energy of the power supply may be renewable or exhaustible, and/or replaceable. For example, the power supply may comprise one or more rechargeable or disposable batteries. In response to the power supply comprising one or more rechargeable batteries, the power supply may be in electric communication with power charging port 126. Power charging port 126 may allow primary recording device 101 to receive electrical power from an external source to charge the power supply.

In various embodiments, provision of power from the power supply may be controlled by power switch 128 and/or the processor. For example, the power switch may be depressed, translated, or otherwise operated to activate (e.g., turn on) or deactivate (e.g., turn off) primary recording device 101. In various embodiments, the processor may also monitor and/or record a power level or remaining power of the power supply. The processor may compare the power level or the remaining power of the power supply to a power threshold and perform one or more operations based on the comparison. For example, in response to the power supply having a low power level or remaining power, the processor may instruct various components of primary recording device 101 and/or an auxiliary recording device to enter a low power mode. Alternatively, the processor may instruct the power supply to cease providing power to the various components of primary recording device 101 and/or the auxiliary recording device. In various embodiments, in response to the remaining power being less than or equal to the power threshold, the processor may instruct the auxiliary recording device to no longer capture incident information (e.g., images). In various embodiments, in response to the remaining power being less than or equal to the power threshold, the processor may instruct the auxiliary recording device to record images at a lower quality setting (e.g., capture lower resolution images). The power threshold may comprise any suitable and/or desired battery level (e.g., 10%, 20%, etc.).

In various embodiments, image capturing system 110 may be configured to capture an image or series of images (e.g., video). For example, during an incident, recording image capturing system 110 may be configured to capture an image or series of images of the incident recording. Image capturing system 110 may comprise various hardware and/or software components configured to capture images and/or video. For example, image capturing system 110 may comprise one or more cameras configured to capture images and/or video. Each camera may comprise a camera lens or plurality of camera lenses. A camera may comprise a narrow angle field of view camera, a wide-angle field of view camera, and/or the like.

Image capturing system 110 may be located on any suitable or desired surface of primary recording device 101 or body 105. For example, image capturing system 110 may be located on a front surface of primary recording device 101.

Image capturing system 110 may be in electric and/or electronic communication with the processor and/or the memory. The processor may control (e.g., instruct) image capturing system 110 to begin capturing images and to end capturing of the images. The processor may also control (e.g., instruct) image capturing system 110 to transmit the captured images to the memory for storage. Image capturing system 110 may transmit (e.g., stream) the captured images to the memory as the images are captured or in response to image capturing system 110 ending capturing of the images.

In various embodiments, a recording device may not comprise an image capturing system. In that regard, in order to capture images of an incident the recording device may communicate with an auxiliary recording device (e.g., auxiliary recording device 102) configured to capture images.

In various embodiments, audio capturing system 112 may be configured to capture audio data. For example, during an incident recording, audio capturing system 112 may be configured to capture audio data of the incident recording. Audio capturing system 112 may comprise various hardware and/or software components configured to capture audio. For example, audio capturing system 112 may comprise one or more microphones configured to capture audio data. Each microphone may be located at any suitable or desired position on primary recording device 101 or body 105. For example, one or more microphones of audio capturing system 112 may be located on a front surface, a first side surface, a second side surface, a top surface, and/or a bottom surface of primary recording device 101.

Audio capturing system 112 may be in electric and/or electronic communication with the processor and/or the memory. The processor may control (e.g., instruct) audio capturing system 112 to begin capturing audio data and to end capturing of the audio data. The processor may also control (e.g., instruct) audio capturing system 112 to transmit the captured audio data to the memory for storage. Audio capturing system 112 may transmit (e.g., stream) the captured audio to the memory as the audio data is captured or in response to audio capturing system 112 ending capturing of the audio data. In various embodiments, audio capturing system 112 may begin and end capturing of the audio data at the same time, or near the same time, as image capturing system 110 begins and ends capturing of images.

In various embodiments, a recording device may not comprise an audio capturing system. In that regard, in order to capture audio of an incident the recording device may communicate with an auxiliary recording device configured to capture audio, or may integrate or communicate with an external microphone, audio capturing device, or the like.

In various embodiments, user interface 116 may be configured to enable a user to interact with primary recording device 101. For example, user interface 116 may be configured to enable the user to control operation of primary recording device 101 and/or an auxiliary recording device, including starting and stopping recording of audio data and/or image data. User interface 116 may be in electrical, electronic, and/or mechanical communication with the processor.

User interface 116 may comprise any suitable hardware, software, mechanical, and/or electronic components configured to enable the user interaction. For example, and in accordance with various embodiments, user interface 116 may comprise a button, switch, or the like. In that regard, user interface 116 may be configured to move, slide, rotate, or otherwise become physically depressed or translated upon application of physical contact. As a further example, and in accordance with various embodiments, user interface 116 may comprise a touchscreen or similar interface enabling user input. As a further example, and in accordance with various embodiments, user interface 116 may include voice control technology. In that regard, user interface 116 may at least partially integrate with audio capturing system 112 to receive voice commands (e.g., “Record”, “Stop Record”, “Capture Image”, “Record Audio”, etc.). User interface 116 may implement any suitable voice command technology.

In various embodiments, in response to user interface 116 receiving an activation event (e.g., physically activation, voice activation, touch-screen selection or activation, etc.), the processor may be configured to perform various operations including starting and/or stopping an incident recording, controlling operation of image capturing system 110, controlling operation of audio capturing system 112, controlling operation of an auxiliary recording device, and/or the like, as discussed further herein. For example, in response to user interface 116 of primary recording device 101 receiving the activation event, the processor may determine or detect the activation event and instruct image capturing system 110 to capture an image or series of images. The processor may also instruct audio capturing system 112 to capture audio data. As a further example, in response to user interface 116 of primary recording device 101 receiving the activation event, the processor may determine or detect the activation event and instruct image capturing system 110 to capture an image or series of images and instruct an auxiliary recording device to also capture an image or series of images. The processor may also instruct audio capturing system 112 to capture audio data. In various embodiments, the processor may be configured to detect whether an auxiliary recording device (e.g., auxiliary recording device 102) is in communication with primary recording device 101 before instructing the auxiliary recording device to capture an image or series of images. In response to determining that an auxiliary recording device is not in communication with primary recording device 101, the processor may only instruct image capturing system 110 to capture an image or series of images. In various embodiments, the processor may be configured to determine recording settings from the memory before instructing an auxiliary recording device to capture image date and/or audio data. The recording settings may comprise configurations, user settings, and/or the like controlling when an auxiliary recording device may be activated.

In various embodiments, user interface 116 may include an authorization control configured to control access and operation of primary recording device 101. For example, user interface 116 may comprise a biometric authorization control, such as a fingerprint reader, configured to control access and operation of primary recording device 101. User interface 116 may implement any suitable authorization control technology and/or biometric authorization technology.

In various embodiments, communications interface 122 may be configured to enable communications between a user of primary recording device 101 and at least a second user. For example, communications interface 122 (together with the processor, the network interface, and other components of primary recording device 101) may be configured to enable communications between users via a communications channel. The communications channel may be private or public. The communications may include push-to-talk (PTT) communications, two-way communications, and/or the like. The communications channel may include a telecommunications network (e.g., a telephonic communication). The telecommunications network may include a public switched telephone network (PSTN), a cellular network or mobile network, a private telephone network (e.g., a private branch exchange (PBX)), an integrated services digital network (ISDN), and/or the like. For example, in a PTT communication a user may operate communications interface 122 to transmit a verbal message (e.g., an audio message).

Audio output system 118 may be configured to output audio from primary recording device 101. For example, audio output system 118 may be configured to output audio from a communication with a second user or device. Audio output system 118 may comprise hardware and/or software configured to output the audio. For example, audio output system 118 may comprise a speaker or plurality of speakers. Operations between communications interface 122 and audio output system 118 may be controlled by the processor.

Audio output system 118 may be located on any suitable and/or desired surface of primary recording device 101 and/or body 105. For example, audio output system 118 may be located on a front surface, a top surface, and/or the like of primary recording device 101.

Audio output volume control 120 may be configured to control (e.g., increase, decrease) a volume of sound output from audio output system 118. Audio output volume control 120 may comprise a button, switch, touchscreen interface, or the like configured to control a volume of sound output from audio output system 118. In response to operation of audio output system 118, the processor and/or audio output system 118 may control the volume of sound output from audio output system 118 accordingly.

In various embodiments, display 124 may be configured to visually display data regarding primary recording device 101, an auxiliary recording device, and/or an incident recording. Display 124 may comprise an LCD screen, output device, or the like configured to visually display data. Operation of display 124 may be at least partially controlled by the processor. For example, display 124 may be configured to display data such as a recording device battery level, an auxiliary recording device battery level, a date, a time, an incident recording status (e.g., recording, paused, etc.), an incident recording length (e.g., an elapsed time of the incident recording), an incident recording start time, and/or the like.

In various embodiments, auxiliary connection port 114 (e.g., primary recording device connection port) may be configured to provide a wired electronic communication between primary recording device 101 and an auxiliary recording device. The wired electronic communication may include the transmission of data to and from the devices. The wired electronic communication may include the transmission of power from primary recording device 101 to the auxiliary recording device. Auxiliary connection port 114 may comprise any suitable type of connection port. For example, in some embodiments, auxiliary connection port 114 may comprise an optical cable connection port configured to enable use of an optical cable between primary recording device 101 and an auxiliary recording device (e.g., auxiliary recording device 102). As a further example, and in some embodiments, auxiliary connection port 114 may comprise a proprietary connector for transmitting data and power to an auxiliary recording device. The proprietary connector may enable transmission of both data and power on a single cable. The proprietary connector may have a separate power cable and a separate data cable configured to provide the transmissions.

In various embodiments, auxiliary recording device 102 (e.g., a first housing, a secondary recording device, a point-of-view (POV) recording device, etc.). Auxiliary recording device 102 may be configured to cooperate with a primary recording device (e.g., primary recording device 101) to capture image data and/or audio data. Auxiliary recording device 102 may comprise any suitable device configured to capture incident information in cooperation with a primary recording device.

Auxiliary recording device 102 may comprise a body 106 (e.g., an auxiliary recording device body, an auxiliary recording device housing, etc.) defining an outer surface of auxiliary recording device 102. Body 106 may comprise a front surface opposite a back surface. Body 106 may comprise a top surface opposite a bottom surface. Body 106 may comprise a first side surface (e.g., a left side surface) opposite a second side surface (e.g., a right side surface).

Body 106 may comprise mechanical features configured to couple auxiliary recording device 102 to a surface. For example, body 106 may comprise a mounting surface 136. Mounting surface 136 may be configured to couple (e.g., mount) to a user. For example, mounting surface 136 may be configured to interface with an article of clothing or a mount assembly on a user. Mounting surface 136 may be configured to mount on a location on the user (e.g., a mount location, a first location, etc.). For example, mounting surface 136 may be configured to couple to a chest mount, a shoulder mount, an eyewear mount, an earpiece mount, a lapel mount, and/or the like. In various embodiments, mounting surface 136 may integrate with an article of clothing at the first location on the user. For example, mounting surface 136 may integrate with or into an eyewear mount or an earpiece mount. In response to being mounted to (or integrated into) the location on the user, auxiliary recording device 102 may be positioned to capture incident information to at least partially align with (or simulate) a visual point of view of the user. In various embodiments, auxiliary recording device 102 may be configured to rotatably mount to the first location on the user.

As a further example, and in accordance with various embodiments, mounting surface 136 may comprise mechanical features or other features configured to enable auxiliary recording device 102 to mount to a different location not on a user. For example, mounting surface 136 may comprise a magnet configured to enable the body to removably couple to a metallic surface, such as a surface of a vehicle, a metal pole, an other metal surface, a shield, a helmet, a drone (e.g., a body of a drone), and/or the like. Mounting surface 136 may also comprise a universal mount such as a clip, a grip, or the like configured to allow auxiliary recording device 102 to fixably couple to an edge surface of an object.

In various embodiments, auxiliary recording device 102 may comprise one or more of an image capturing system 130, an audio capturing system 132, and/or an auxiliary connection port 134.

In some embodiments, auxiliary recording device 102 may also comprise one or more of a processor, a memory, a network interface, a power supply, and/or the like. The processor may be similar to any other processor disclosed herein. The memory may be similar to any other memory disclosed herein. The network interface may be similar to any other network interface disclosed herein. The power supply may be similar to any other power supply disclosed herein. In some embodiments, primary recording device 101 may not comprise one or more of a processor, a memory, a network interface, a power supply, and/or the like. In various embodiments, auxiliary recording device 102 may comprise a memory configured to buffer or temporarily store images before transmission to a (primary) recording device. The memory may comprise any type of memory described herein.

In various embodiments, body 106 may be configured to house (fully and/or at least partially) various mechanical, electrical, and/or electronic components configured to aid in performing the functions of auxiliary recording device 102. For example, and in accordance with various embodiments, the body of auxiliary recording device 102 may be configured to house (fully and/or at least partially) an image capturing system 130 (e.g., an auxiliary image capturing system), an audio capturing system 132 (e.g., an auxiliary audio capturing system), and/or the like.

In various embodiments, image capturing system 130 may be configured to capture an image or series of images (e.g., video). For example, during an incident recording, image capturing system 130 may be configured to capture an image or series of images of the incident recording. Image capturing system 130 may comprise various hardware and/or software components configured to capture images and/or video. For example, image capturing system 130 may comprise one or more cameras configured to capture images and/or video. Each camera may comprise a camera lens. A camera may comprise a narrow-angle field of view camera, a wide-angle field of view camera, and/or the like.

In various embodiments, a camera may comprise a plurality of camera lenses (e.g., a multi-lens camera). For example, a camera may comprise a forward capture lens configured to capture images at least partially forward the user, and a rearward capture lens configured to capture images at least partially rearward the user. A camera may also comprise one or more side or profile capture lenses configured to capture images peripheral the user. A processor of the camera may coordinate with the plurality of camera lenses to capture images at a same time, or near same time.

In various embodiments, image capturing system 130 may comprise an omnidirectional camera. The omnidirectional camera may be configured to capture a 360-degree field of view relative to the body of auxiliary recording device 102. The omnidirectional camera may comprise a camera lens having a 360-degree field of view, or a plurality of camera lenses enabling a 360-degree field of view. The omnidirectional camera may be configured to output images and/or series of images as monoscopic video or stereoscopic video.

In various embodiments, image capturing system 130 may comprise an infrared camera. The infrared camera may comprise any suitable infrared camera, including short wavelength infrared (SWIR), medium wavelength infrared (MWIR), and/or long wavelength infrared (LWIR). The infrared camera may be configured to detect infrared energy (heat), convert the detected infrared heat into an electronic signal, and process the electronic signal to produce a thermal image.

Image capturing system 130 may be located on any suitable or desired surface of auxiliary recording device 102 or body 106. For example, image capturing system 130 may be located on a front surface of auxiliary recording device 102.

In various embodiments, image capturing system 130 may be in electric and/or electronic communication with a processor of a primary recording device (e.g., primary recording device 101). The processor may control (e.g., instruct) image capturing system 130 to begin capturing image data and to end capturing of the image data. The processor may also control (e.g., instruct) image capturing system 130 to transmit the captured image data to a memory of the primary recording device for storage. Image capturing system 130 may transmit (e.g., stream) the captured image data to the memory as the image data is captured or in response to image capturing system 130 ending capturing of the image data.

In various embodiments, image capturing system 130 may be configured to capture image data as uncompressed, raw data. The uncompressed, raw data may be transmitted to a primary recording device (e.g., primary recording device 101) for processing. In that regard, image capturing system 130 and/or auxiliary recording device 102 may not process image data before transmitting the image data to the primary recording device.

In various embodiments, audio capturing system 132 may be configured to capture audio data. For example, during an incident recording, audio capturing system 132 may be configured to capture audio data of the incident recording. Audio capturing system 132 may comprise various hardware and/or software components configured to capture audio. Audio capturing system 132 may be similar to any other audio capturing system, microphone, and/or the like disclosed herein. Audio capturing system 132 may comprise one or more microphones configured to capture audio data. Each microphone may be located at any suitable or desired position on auxiliary recording device 102 or body 106. For example, one or more microphones of audio capturing system 132 may be located on a front surface, a first side surface, a second side surface, a top surface, and/or a bottom surface of auxiliary recording device 102.

In various embodiments, audio capturing system 132 may be in electric and/or electronic communication with a processor of a primary recording device (e.g., primary recording device 101). The processor may control (e.g., instruct) audio capturing system 132 to begin capturing audio data and to end capturing of the audio data. The processor may also control (e.g., instruct) audio capturing system 132 to transmit the captured audio data to a memory of the primary recording device for storage. Audio capturing system 132 may transmit (e.g., stream) the captured audio data to the memory as the audio data is captured or in response to audio capturing system 132 ending capturing of the audio data.

In various embodiments, audio capturing system 132 may be configured to capture audio data as uncompressed, raw data. The uncompressed, raw data may be transmitted to a primary recording device (e.g., primary recording device 101) for processing. In that regard, audio capturing system 132 and/or auxiliary recording device 102 may not process audio data before transmitting the audio data to the primary recording device.

In various embodiments, auxiliary recording device 102 may be configured to receive instructions from a processor of a primary recording device to control operations of auxiliary recording device 102. In various embodiments, auxiliary recording device 102 may also comprise a user interface configured to at least partially control operations of auxiliary recording device. The user interface may comprise a button, switch, or the like and may be similar to any user interface described herein. The user interface may be configured to receive an activation event, and in response to the activation event, operate image capturing system 130, audio capturing system 132, and/or the like (e.g., instruct image capturing system 130 to capture image data, instruct audio capturing system 132 to capture audio data, etc.).

In various embodiments, a network interface of auxiliary recording device 102 may be configured to enable the transmission and/or reception of data between auxiliary recording device 102 and one or more additional devices, servers, networks, or the like. For example, the network interface may be configured to enable the transmission and/or reception of data between auxiliary recording device 102 and a primary recording device. The network interface may be similar to any network interface discussed herein. The network interface may comprise one or more suitable hardware and/or software components capable of enabling the transmission and/or reception of data, such as, for example, a communications unit, a transmitter, and/or a receiver as discussed further herein. In various embodiments, auxiliary recording device 102 may only have a transmitter configured to transmit data (e.g., images, video, etc.) to a primary recording device. In various embodiments, auxiliary recording device 102 may have a transmitter and a receiver to transmit data (e.g., images, video, etc.) to and receive data (e.g., instructions) from a primary recording device.

In various embodiments, auxiliary recording device 102 may receive power from a primary recording device to power electrical components of auxiliary recording device 102. In various embodiments, auxiliary recording device 102 may comprise a power supply configured to at least partially provide onboard power to electrical components of auxiliary recording device 102. The power supply may comprise any battery, power supply, power source, or the like discussed herein.

In various embodiments, auxiliary recording device 102 may also comprise a light emitting source configured to emit light external the auxiliary recording device. The light emitting source may be configured to emit the light from (or through) an exterior surface of the body of auxiliary recording device 102. The light emitting source may comprise one or more components configured to emit light such as, for example, one or more light emitting components, flashlights, light emitting diodes (LED), and/or the like. The components may be arranged in any suitable manner, and may comprise individual light emitting components (e.g., an individual light, etc.), collective light emitting components (e.g., a light bar, a light strip, etc.), and/or a combination thereof. The light emitting source may be configured to receive power from an onboard power supply integrated into the light emitting source, a power supply of auxiliary recording device 102, and/or a power supply of a primary recording device in electric communication with auxiliary recording device 102.

In various embodiments, a processor of a primary recording device in communication with auxiliary recording device 102 may be configured to control operation of the light emitting source. For example, in response to determining an activation event the processor of the primary recording device may instruct image capturing system 130 to begin capturing image data, audio capturing system 132 to begin capturing audio data, and/or the light emitting source to begin emitting light. In various embodiments, the light emitting source may include a button, switch, or the like configured to enable a user to manually control operation of the light emitting source.

In various embodiments, auxiliary recording device 102 may comprise an onboard processor configured to perform various operations of auxiliary recording device 102, including operation of image capturing system 130. The processor may be similar to any processor, processing circuit, or the like described herein.

In various embodiments, auxiliary connection port 134 (e.g., auxiliary recording device connection port) may be configured to provide a wired electronic communication between a primary recording device (e.g., primary recording device 101) and auxiliary recording device 102. The wired electronic communication may include the transmission of data to and from the devices. The wired electronic communication may include the transmission of power from the primary recording device to auxiliary recording device 102. Auxiliary connection port 134 may be similar to any other connection port, auxiliary connection port, or the like disclosed herein. Auxiliary connection port 134 may comprise any suitable type of connection port. For example, in some embodiments, auxiliary connection port 134 may comprise an optical cable connection port configured to enable use of an optical cable, proprietary cable, or the like between the primary recording device and auxiliary recording device 102. As a further example, and in some embodiments, auxiliary connection port 134 may comprise a universal serial bus (USB) type C (USB-C) connection port configured to enable use of a USB cable, proprietary cable, or the like between the primary recording device and auxiliary recording device 102. As a further example, and in some embodiments, auxiliary connection port 134 may comprise a proprietary connector for transmitting data and power to an auxiliary recording device. The proprietary connector may enable transmission of both data and power on a single cable. The proprietary connector may have a separate power cable and a separate data cable configured to provide the transmissions.

In various embodiments, recording system 100 may comprise a connecting cable 140 (e.g., a curly connecting cable, a spiral connecting cable, a coiled connecting cable, etc.). Connecting cable 140 may be configured to electrically and/or electronically couple primary recording device 101 to auxiliary recording device 102. Connecting cable 140 may comprise a first connecting end 141 opposite a second connecting end 142. First connecting end 141 may terminate with a first connector 143. Second connecting end 142 may terminate with a second connector 144. First connector 143 and second connector 144 may each comprise a male connector configured to coupled to a female connector of primary recording device 101 and/or auxiliary recording device 102. For example, first connector 143 and/or second connector 144 may be configured to couple to auxiliary connection port 114 of primary recording device 101 and/or auxiliary connection port 134 of auxiliary recording device 102.

In some embodiments, first connector 143 may be capable of coupling to either of primary recording device 101 or auxiliary recording device 102, and second connector 144 may be capable of coupling to either of primary recording device 101 or auxiliary recording device 102. In some embodiments, first connector 143 may be capable of coupling to one of primary recording device 101 or auxiliary recording device 102, and second connector 144 may be capable of coupling to the other of primary recording device 101 or auxiliary recording device 102.

Connecting cable 140 may be configured to provide data transmission capabilities between primary recording device 101 and auxiliary recording device 102. For example, connecting cable 140 may be configured to allow primary recording device 101 to transmit data (e.g., instructions, recording instructions, lighting instructions, etc.) to auxiliary recording device 102 and receive data (e.g., incident recordings, image data, audio data, etc.) from auxiliary recording device 102. Connecting cable 140 may be configured to allow auxiliary recording device 102 to receive data (e.g., instructions recording instructions, lighting instructions, etc.) from primary recording device 101 and transmit data (e.g., incident recordings, image data, audio data, etc.) to primary recording device 101.

Connecting cable 140 may be configured to provide power between primary recording device 101 and auxiliary recording device 102. For example, connecting cable 140 may be configured to allow primary recording device 101, via a power supply, to provide power to auxiliary recording device 102. In some embodiments, auxiliary recording device 102 may rely on power from primary recording device 101, provided via connecting cable 140, in order to operate. In some embodiments, auxiliary recording device 102 may at least partially rely on power from primary recording device 101, provided via connecting cable 140, in order to operate. In some embodiments, auxiliary recording device 102 may be capable of operating with or without power from primary recording device 101, provided via connecting cable 140.

In various embodiments, connecting cable 140 may comprise a coiled portion 145. Coiled portion 145 may be defined between first connecting end 141 and second connecting end 142. Coiled portion 145 may comprise a portion of connecting cable 140 wound into a coil.

In some embodiments, coiled portion 145, first connecting end 141, and second connecting end 142 may each comprise equal portions of connecting cable 140. In some embodiments, coiled portion 145 may comprise a greater portion of connecting cable 140 than first connecting end 141 and second connecting end 142. In some embodiments, coiled portion 145 may comprise a greater portion of connecting cable 140 than one of first connecting end 141 or second connecting end 142, and a lesser portion of connecting cable 140 than the other of first connecting end 141 or second connecting end 142. In some embodiments, first connecting end 141 and second connecting end 142 may each comprise a greater portion of connecting cable 140 than coiled portion 145.

In various embodiments, coiled portion 145 may be configured to allow connecting cable 140 to elongate and/or compress during operation of recording system 100. For example, coiled portion 145 may be configured to between a first position (e.g., a compressed position, a coiled position, a resting position, etc.) to a second position (e.g., a stretched position, an elongated position, etc.). Coiled portion 145 may comprise a compressed length (e.g., a first length) in the first position and an elongated length (e.g., a second length) in the second position. The elongated length may be longer than the compressed length.

Coiled portion 145 may be configured to translate in response to receiving a force. The force may be applied on first connecting end 141 and/or second connecting end 142. The force may cause a distance between first connecting end 141 and second connecting end 142 to increase. For example, in response to receiving the force, coiled portion 145 may translate from the first position to the second position. In response to the force no longer being applied, coiled portion 145 may translate from the second position to the first position.

As previously discussed, during operation of recording system 100 it may be desirable to mount primary recording device 101 and/or auxiliary recording device 102 at different locations. Additional movement by a user may cause movement of primary recording device 101 and/or auxiliary recording device 102, and/or a change in distance between primary recording device 101 and auxiliary recording device 102. Coiled portion 145 may be configured to allow primary recording device 101 and auxiliary recording device 102 to change positions and relative distances from each other while connecting cable 140 remains coupled to each of primary recording device 101 and auxiliary recording device 102.

In various embodiments, primary recording device 101 and auxiliary recording device 102 may be configured to mount on different locations of a user. For example, primary recording device 101 may be configured to mount on a first location on the user and auxiliary recording device 102 may be configured to mount on a second location of the user. The first location may be different from the second location. For example, the first location may be on a torso of the user and the second location may be proximate a head of the user.

In various embodiments, primary recording device 101 and auxiliary recording device 102 may be configured to capture data (e.g., images, audio, etc.) from different perspectives (e.g., angles, views, vantage points, etc.) of the user. For example, primary recording device 101 may be configured to capture data from a first perspective (e.g., first vantage point) of the user and auxiliary recording device 102 may be configured to capture data from a second perspective (e.g., second vantage point) of the user. The first perspective may be different from the second perspective. For example, the first perspective may be configured to capture a wide field of view from the body of the user and the second perspective may be configured to capture a narrow field of view from the head of the user. In that regard, the second perspective may be configured to imitate what the user is seeing.

For example, FIG. 1B depicts recording system 100 with primary recording device 101 mounted on or proximate a belt of a user (e.g., a first location, a first perspective, etc.) and auxiliary recording device 102 mounted on or proximate a shoulder of the user (e.g., a second location, a second perspective, etc.). Given the increased distance between the belt and the shoulder of the user, a force is applied on connecting cable 140 (e.g., at first connecting end 141 and/or second connecting end 142). The force may cause coiled portion 145 to translate from the first position to the second position (e.g., as depicted in FIG. 1B).

As a further example, FIG. IC depicts recording system 100 with primary recording device 101 mounted on or proximate a chest of a user (e.g., a first location, a first perspective, etc.) and auxiliary recording device 102 mounted on or proximate a head of the user (e.g., a second location, a second perspective, etc.). Given the decreased distance between the chest and the head of the user, a force is not applied to or is limited on connecting cable 140. Coiled portion 145 may remain in the first position (e.g., as depicted in FIG. 1C).

In various embodiments, connecting cable 140 may comprise a fiber channel (e.g., an optical fiber channel). The fiber channel may be configured to transmit data via pulse of light transmitted within the fiber channel. The fiber channel may comprise a glass core configured to allow for the transmission and pulses of light. The fiber channel may allow for the transmission of more data and at faster data transfer speeds compared to traditional copper wires. Use of a fiber channel may be beneficial in an exemplary recording system 100 wherein auxiliary recording device 102 transmits raw data (e.g., unprocessed and/or uncompressed incident recordings) to primary recording device 101.

Fiber channels are typically fragile and brittle. Damage to a fiber channel may interfere with the pulses of light transmitted within the fiber channel, causing the fiber channel to fail during data transmission. In various embodiments, coiled portion 145 may be configured to allow connecting cable 140 to receive force, stretch, and/or compress while minimizing damaging force and tension applied to the fiber channel. In that regard, coiled portion 145 may be sized, shaped, and wound to minimize force and tension applied to the fiber channel during operation of connecting cable 140.

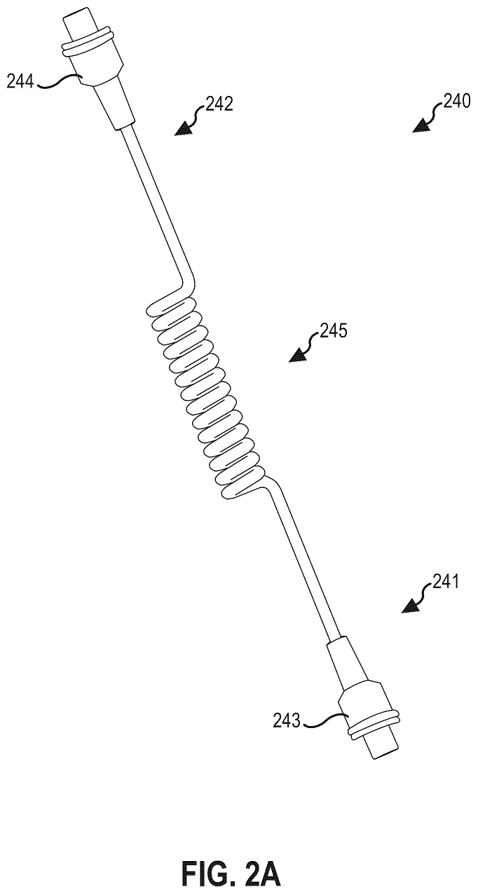

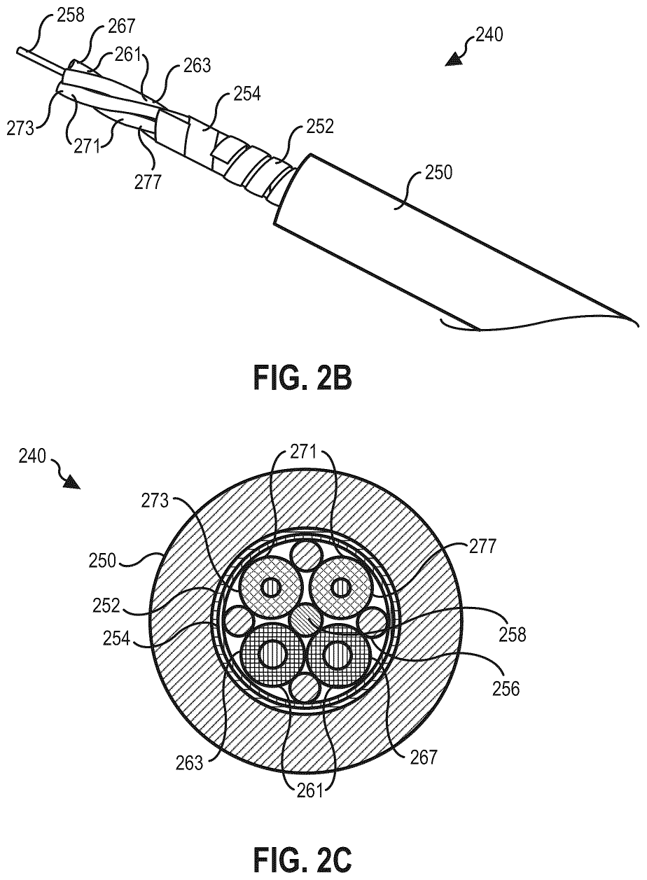

In various embodiments, and with reference to FIGS. 2A-2C, a connecting cable 240 is disclosed. Connecting cable 240 may be similar to any other connecting cable disclosed herein (e.g., connecting cable 140, with brief reference to FIGS. 1A-1C). Connecting cable 240 may comprise a first connecting end 241 opposite a second connecting end 242. First connecting end 241 may terminate with a first connector 243. First connecting end 241 and first connector 243 may be similar to any other first connecting end and/or first connector disclosed herein (e.g., first connecting end 141 and first connector 143, with brief reference to FIGS. 1A-1C). Second connecting end 242 may terminate with a second connector 244. Second connecting end 242 and second connector 244 may be similar to any other second connecting end and/or second connector disclosed herein (e.g., second connecting end 142 and second connector 144, with brief reference to FIGS. 1A-1C). First connector 243 and second connector 244 may each comprise a male connector configured to couple to a female connector of a primary recording device and/or an auxiliary recording device.

In various embodiments, connecting cable 240 may comprise a coiled portion 245. Coiled portion 245 may be similar to any other coiled portion of a connecting cable disclosed herein (e.g., coiled portion 145, with brief reference to FIGS. 1A-1C). Coiled portion 245 may be defined between first connecting end 241 and second connecting end 242. Coiled portion 245 may comprise a portion of connecting cable 240 wound into a coil.

In various embodiments, coiled portion 245 may be configured to allow connecting cable 240 to elongate and/or compress. For example, coiled portion 245 may be configured to translate from a first position (e.g., a compressed position, a coiled position, etc.) to a second position (e.g., a stretched position, an elongated position, etc.). Coiled portion 245 may comprise a compressed length (e.g., a first length) in the first position and an elongated length (e.g., a second length) in the second position. The elongated length may be longer than the compressed length.

Coiled portion 245 may be configured to translate in response to receiving a force. The force may be applied on first connecting end 241 and/or second connecting end 242. The force may cause a distance between first connecting end 241 and second connecting end 242 to increase. For example, in response to receiving the force, coiled portion 245 may translate from the first position to the second position. In response to the force no longer being applied, coiled portion 245 may translate from the second position to the first position.

In various embodiments, connecting cable 240 may comprise a plurality of layers covering an elongated core. The plurality of layers may be radially outward for the elongated core. The plurality of layers may be configured to protect, insulate, and/or the like the elongated core. The plurality of layers may be configured to constrict and/or compress the elongated core. The elongated core may be radially inward from the plurality of layers. The elongated core may be configured to provide one or more data transmission channels and/or power transmission channels for connecting cable 240. The elongated core may comprise an outer elongated core and an inner elongated core. The outer elongated core may be radially outward the inner elongated core. The outer elongated core may be configured to provide one or more power transmission channels and/or one or more data transmission channels. The inner elongated core may be radially inward the outer elongated core. The inner elongated core may comprise a fiber channel configured to provide a data transmission channel.

In various embodiments, connecting cable 240 may comprise a plurality of layers including an outer layer 250, a shield layer 252, and/or a tape layer 254. Connecting cable 240 may comprise an elongated core including an outer elongated core comprising one or more power channels 261, one or more data channels 271, and/or one or more fillers 256, and an inner elongated core comprising a fiber channel 258.

In various embodiments, outer layer 250 (e.g., outer jacket) may be configured to provide an outer protective layer of connecting cable 240. For example, outer layer 250 may be configured to provide fire resistance, moisture resistance, and/or the like. Outer layer 250 may comprise a flexible material. Outer layer 250 may comprise a non-conductive, insulating material. Outer layer 250 may comprise any suitable material. For example, outer layer 250 may comprise a rubber material, a plastic material, an elastomeric material, a compliant material, or the like. Outer layer 250 may comprise a polyethylene (PE) material, a polyvinyl chloride (PVC) material, a polyvinyl difluoride (PVDF) material, a low smoke zero halogen (LSZH) material, and/or the like. Outer layer 250 may comprise a polyurethane tubing (e.g., polyurethane 85 A tubing).

In various embodiments, shield layer 252 may be configured to provide protection against interference from external environmental sources. Shield layer 252 may be configured to at least partially minimize signal loss and ensure reliable data transmission. Shield layer 252 may be configured to provide a barrier separating the elongated core of connecting cable 240 from external electromagnetic interference (EMI), radio frequency interference (RFI), and/or the like. Shield layer 252 may comprise any suitable material. For example, shield layer 252 may comprise an aluminum foil, a copper foil, and/or the like. Shield layer 252 may comprise a tinned copper. Shield layer 252 may comprise a woven mesh of metallic wires. Shield layer 252 may comprise a layer of steel, aluminum, or the like configured to additionally provide physical protection of the elongated core of connecting cable 240.

In various embodiments, tape layer 254 may be configured to compress and maintain structure of the elongated core of connecting cable 240. Tape layer 254 may be configured to provide environmental protection to the elongated core, such as, for example, by providing at least partial waterproofing sealing. Tape layer 254 may comprise an adhesive configured to contact, compress, and couple around the elongated core. Tape layer 254 may not comprise an adhesive and may be configured to contact and couple around the elongated core by compressing the elongated core. Tape layer 254 may comprise any suitable material. For example, tape layer 254 may comprise a plumbing tape (e.g., plumber's tap, water pipe sealing tape, etc.). Tape layer 254 may comprise a fluoropolymer tape, such as, for example, a polytetrafluoroethylene (PTFE) tape (e.g., such as PTFE tape commonly known under the trademark TEFLON sold by the Chemours Company).

In various embodiments, each layer of the plurality of layers of connecting cable 240 may comprise varying thicknesses. For example, outer layer 250 may comprise a first thickness, shield layer 252 may comprise a second thickness, and tape layer 254 may comprise a third thickness. The first thickness, the second thickness, and the third thickness may each comprise different thicknesses. The first thickness may be greater than the second thickness and the third thickness. The first thickness may be greater than the second thickness combined with the third thickness. The second thickness may be greater than the third thickness. The second thickness may be similar to the third thickness. The second thickness may be less than the first thickness. The third thickness may be less than the second thickness. The third thickness may be similar to the second thickness. The third thickness may be less than the first thickness.

In various embodiments, power channels 261 may be configured to provide for the transmission of electrical power between first connector 243 and second connector 244. For example, power channels 261 may enable a first device connected to first connector 243 (e.g., a primary recording device) to provide power to a second device connected to second connector 244 (e.g., an auxiliary recording device). Power channels 261 may comprise any suitable material, component, or cable. For example, power channels 261 may comprise a copper cabling. Power channels 261 may comprise a copper core surrounded by an insulating outer layer. The insulating outer layer may comprise any suitable insulating layer, such as, for example, a fluoropolymer insulation, a fluorinated ethylene propylene (FEP) insulation, and/or the like. Power channels 261 may comprise any suitable gauge capable of providing electrical power.

In various embodiments, power channels 261 may comprise a plurality of power channels 261. For example, power channels 261 may comprise a first power channel 263 (e.g., a positive power channel) and a second power channel 267 (e.g., a negative power channel, a ground power channel, etc.). First power channel 263 and second power channel 267 may be configured to provide an electrical circuit through connecting cable 240. For example, first power channel 263 may be configured to provide a positive signal path for connecting cable 240 and second power channel 267 may be configured to provide a ground signal path (or negative signal path) for connecting cable 240. First power channel 263 may be in electrical series with first connector 243 and second connector 244. Second power channel 267 may be in electrical series with first connector 243 and second connector 244. In that regard, in response to connecting cable 240 being coupled at first connector 243 to a first device (e.g., a primary recording device) and at second connector 244 to a second device (e.g., an auxiliary recording device), an electrical circuit may be established between the first device, first connector 243, first power channel 263, second power channel 267, second connector 244, and the second device.

In various embodiments, data channels 271 may be configured to provide for the transmission of data (e.g., instructions) between first connector 243 and second connector 244. For example, data channels 271 may enable a first device connected to first connector 243 (e.g., a primary recording device) to transmit data to and/or receive data from a second device connected to second connector 244 (e.g., an auxiliary recording device). Data channels 271 may also enable a second device connected to second connector 244 (e.g., an auxiliary recording device) to receive data from and/or transmit data to a first device connected to first connector 243 (e.g., a primary recording device). Data channels 271 may comprise any suitable material, component, or cable. For example, data channels 271 may comprise a coaxial cable, a micro-coaxial cable, and/or the like. Data channels 271 may comprise a copper core surrounded by an insulating outer layer. The insulating outer layer may comprise any suitable insulating layer, such as, for example, a fluoropolymer insulation, a perfluoroalkoxy (PFA) insulation, and/or the like. Data channels 271 may comprise any suitable gauge capable of enabling data transmissions.

In various embodiments, data channels 271 may comprise a plurality of data channels 271. For example, data channels 271 may comprise a first data channel 273 and a second data channel 277. First data channel 273 and second data channel 277 may be configured to provide for data transmission through connecting cable 240. In some embodiments, first data channel 273 and second data channel 277 may enable one-way data transmission through connecting cable 240. In some embodiments, first data channel 273 and second data channel 277 may enable two-way data transmission through connecting cable 240. In some embodiments, first data channel 273 may enable a first device (e.g., a primary recording device) coupled to first connector 243 to transmit data to a second device (e.g., an auxiliary recording device) coupled to second connector 244. First data channel 273 may enable the second device to receive data from the first device. In some embodiments, second data channel 277 may enable a second device (e.g., an auxiliary recording device) coupled to second connector 244 to transmit data to a first device (e.g., a primary recording device) coupled to first connector 243. Second data channel 277 may enable the first device to receive data from the second device.

In various embodiments, fillers 256 may be configured to maintain spacing and compression of other components in an elongated core of connecting cable 240. Fillers 256 may be configured to at least partially limit or reduce movement of other components in an elongated core of connecting cable 240 during operation of connecting cable 240, including during translation of coiled portion 245 between a first position and a second position. Fillers 256 may be configured to provide tensile strength and integrity to connecting cable 240 during operation of connecting cable 240, including during translation of coiled portion 245 between a first position and a second position. Connecting cable 240 may comprise any suitable number of fillers 256. For example, in some embodiments connecting cable 240 may comprise two fillers 256, four fillers 256, and/or the like. Fillers 256 may comprise any suitable material, component, cable, and/or the like. For example, fillers 256 may comprise an aramid yarn.

In various embodiments, fiber channel 258 may be configured to provide for the transmission of data (e.g., raw data) between first connector 243 and second connector 244. For example, fiber channel 258 may enable a second device connected to second connector 244 (e.g., an auxiliary recording device) to transmit raw data to a first device connected to first connector 243 (e.g., a primary recording device). Fiber channel 258 may comprise any suitable material, component, or cable. For example, fiber channel 259 may comprise an optical fiber channel. An optical fiber channel may be configured to provide for transmitting large amounts of raw data at higher transmission speeds compared to typical copper cables. Fiber channel 259 may comprise any suitable type of optical fiber channel, such as, for example, an OMI cable.

In various embodiments, the plurality of layers, the outer elongated core, and the inner elongated core of connecting cable 240 may be coaxially positioned. For example, outer layer 250, shield layer 252, tape layer 254, power channels 261, data channels 271, fillers 256, and fiber channel 258 may be coaxially positioned.

In various embodiments, the inner elongated core may be surrounded by the outer elongated core. The outer elongated core may be surrounded by the plurality of layers. For example, fiber channel 258 may be disposed through a middle of connecting cable 240. Power channels 261, data channels 271, and fillers 256 may be disposed radially outward from fiber channel 258. Tape layer 254 may be disposed radially outward from power channels 261, data channels 271, and fillers 256. Tape layer 254 may be coupled to one or more of power channels 261, data channels 271, and fillers 256. Shield layer 252 may be disposed radially outward from tape layer 254. Shield layer 252 may be coupled to tape layer 254. Outer layer 250 may be disposed radially outward from shield layer 252. Outer layer 250 may be coupled to shield layer 252.

In various embodiments, one or more of the plurality of layers, the outer elongated core, and/or coiled portion 245 may be wound in a direction. For example, power channels 261, data channels 271, and/or fillers 256 may be wound around fiber channel 258 (e.g., a first winding layer). Power channels 261, data channels 271, and/or fillers 256 may be wound circumferentially and/or axially around fiber channel 258. Power channels 261, data channels 271, and/or fillers 256 may be wound around fiber channel 258 from first connecting end 241 to second connecting end 242. Power channels 261, data channels 271, and/or fillers 256 may comprise a spiral winding. Power channels 261, data channels 271, and/or fillers 256 may be wound in a first direction. The first direction may comprise a left-hand winding (e.g., a winding in a counterclockwise direction). Power channels 261, data channels 271, and/or fillers 256 may be collectively wound in the first direction such that lengths of power channels 261, data channels 271, and/or fillers 256 are adjacent throughout the winding.

As a further example, tape layer 254 may be wound around power channels 261, data channels 271, and/or fillers 256 (e.g., a second winding layer). Tape layer 254 may be wound circumferentially and/or axially around power channels 261, data channels 271, and/or fillers 256. Tape layer 254 may be wound around power channels 261, data channels 271, and/or fillers 256 from first connecting end 241 to second connecting end 242. Tape layer 254 may comprise a spiral winding. Tape layer 254 may be wound in a second direction. The second direction may be different from the first direction. The second direction may comprise a right-hand winding (e.g., a winding in a clockwise direction). Tape layer 254 may be wound in the second direction such that axially adjacent portions of the winding at least partially overlap (e.g., a first adjacent portion of the winding axially overlaps with a second adjacent portion of the winding). Overlapping of the winding of tape layer 254 may at least partially improve environmental sealing provided by tape layer 254. Axially adjacent portions of tape layer 254 may overlap at any suitable or desired amount.

As a further example, shield layer 252 may be wound around tape layer 254 (e.g., a third winding layer). Shield layer 252 may be wound circumferentially and/or axially around tape layer 254. Shield layer 252 may be wound around tape layer 254 from first connecting end 241 to second connecting end 242. Shield layer 252 may comprise a spiral winding. Shield layer 252 may be wound in a third direction. The third direction may be different from the second direction. The third direction may be the same as, or similar to, the first direction. The third direction may comprise a left-hand winding (e.g., a winding in a counterclockwise direction). Shield layer 252 may be wound in the third direction such that axially adjacent portions of the winding do not overlap (e.g., a first adjacent portion of the winding does not axially overlap with a second adjacent portion of the winding). In that regard, there may be an axial gap between axially adjacent portions of the winding of shield layer 252. Axial gaps between each axially adjacent portion of the winding of shield layer 252 may comprise any suitable or desired distance.

As a further example, coiled portion 245 may be wound in a fourth direction (e.g., connecting cable at coiled portion 245 may be wound in the fourth direction while connecting cable at first connecting end 241 and second connecting end 242 are not wound) (e.g., a fourth winding). The fourth direction may be different from the third direction and/or the first direction. The fourth direction may be the same as, or similar to, the second direction. The fourth direction may comprise a right-hand winding (e.g., a winding in a clockwise direction). As previously discussed, winding coiled portion 245 in the fourth direction may be configured to allow coiled portion 245 to translate from a first position to a second position during use of connecting cable 240.

In that regard, and in accordance with various embodiments, connecting cable 240 may comprise fiber channel 258 surrounded by a first winding layer, a second winding layer, and a third winding layer, wherein connecting cable 240 comprise a fourth winding (e.g., at coiled portion 245). The first winding layer and the third winding layer may be wound in the same or similar directions. The second winding layer and the fourth winding may be wound in the same or similar directions. The first winding layer and the third winding layer may be wound in a different direction compared to the second winding layer and the fourth winding. The first winding layer, the second winding layer, and the third winding layer may extend from first connecting end 241 to second connecting end 242 (e.g., a first winding length). The fourth winding may extend a length of coiled portion 245 (e.g., a second winding length). The first winding length may be greater than the second winding length.

In various embodiments, winding different portions of connecting cable 240 in different directions may increase tensile strength in connecting cable 240. As previously discussed, fiber channels (such as fiber channel 258) are typically fragile and brittle, and susceptible to damage in response to the fiber channel receiving force, stretch, compression, or the like. In that regard, the winding of different portions of connecting cable 240 in different directions may be wound and configured to minimize force and tension applied to the fiber channel during operation of connecting cable 140.

For example, as previously discussed and in accordance with various embodiments, power channels 261, data channels 271, and/or fillers 256 and shield layer 252 may be wound in a same or similar direction (e.g., the first direction and the third direction, respectively). Tape layer 254 and coiled portion 245 may be wound in a same or similar direction (e.g., the second direction and the fourth direction, respectively). Therefore, power channels 261, data channels 271, fillers 256, and shield layer 252 may be wound in a different and opposite direction than tape layer 254 and coiled portion 245. In response to coiled portion 245 translating from the first position to the second position, winding of tape layer 254 may tighten around the winding of power channels 261, data channels 271, and/or fillers 256, while the winding of power channels 261, data channels 271, and/or fillers 256 straightens out from the initial winding position. In the second position, shield layer 252 may also straighten out from the initial winding position to remain consistent with winding of power channels 261, data channels 271, and/or fillers 256. This may result in a decrease of tension and stress on fiber channel 258 compared to connecting cables having different or no winding arrangements.

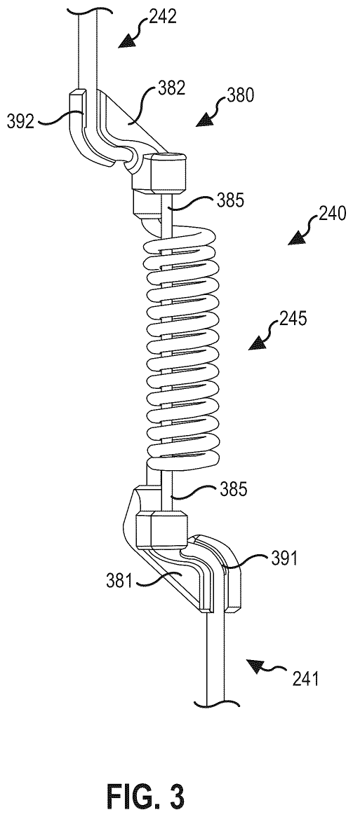

In various embodiments, and with reference to FIG. 3 a cable stretch limiter 380 is disclosed. Cable stretch limiter 380 may be configured to limit extension of coiled portion 245 in response to coiled portion 245 translating (e.g., extending, stretching, etc.) from a first position to a second position. Limiting extension of coiled portion 245 may improve functionality of connecting cable 240, including, for example, by decreasing a probability that coiled portion 245 may over-extend and cause damage to connecting cable 240 and/or components of connecting cable 240 (e.g., a fiber channel).

In various embodiments, cable stretch limiter 380 may comprise a first end bracket 381 opposite a second end bracket 382. First end bracket 381 and second end bracket 382 may be similar in size, shape, and functionality. First end bracket 381 and second end bracket 382 may be symmetrical. First end bracket 381 and second end bracket 382 may comprise a same component. First end bracket 381 and second end bracket 382 may comprise any suitable material. For example, first end bracket 381 and second end bracket 382 may comprise a plastic material and/or any other rigid material.

In various embodiments, first end bracket 381 may comprise a first cable channel 391. First cable channel 391 may be defined on an outer surface of first end bracket 381. First cable channel 391 may be defined on a top surface and/or a bottom surface of first end bracket 381. In some embodiments, a first portion (e.g., a first axially outer portion) of first cable channel 391 may be defined and open a top surface of first end bracket 381 and a second portion (e.g., a first axially inner portion) of first cable channel 391 may be defined and open on a bottom surface of first end bracket 381. The first portion may be similar in surface area to the second portion.

First cable channel 391 may be configured to receive a portion of first connecting end 241. First cable channel 391 may be sized and shaped to receive and retain the portion of first connecting end 241. First cable channel 391 may be sized and shaped to increase surface friction between surfaces of first cable channel 391 and the portion of first connecting end 241. For example, first cable channel 391 may comprise one or more channel surface features (e.g., curves, bends, and/or the like) configured to increase surface friction with the portion of first connecting end 241. Increasing surface friction between surfaces of first cable channel 391 and the portion of first connecting end 241 may at least partially aid first cable channel 391 to retain the portion of first connecting end 241.

In various embodiments, second end bracket 382 may comprise a second cable channel 392. Second cable channel 392 may be defined on an outer surface of second end bracket 382. Second cable channel 392 may be defined on a top surface and/or a bottom surface of second end bracket 382. In some embodiments, a first portion (e.g., a second axially outer portion) of second cable channel 392 may be defined and open on a top surface of second end bracket 382 and a second portion (e.g., a second axially inner portion) of second cable channel 392 may be defined and open on a bottom surface of second end bracket 382. The first portion may be similar in surface area to the second portion.

Second cable channel 392 may be configured to receive a portion of second connecting end 242. Second cable channel 392 may be sized and shaped to receive and retain the portion of second connecting end 242. Second cable channel 392 may be sized and shaped to increase surface friction between surfaces of second cable channel 392 and the portion of second connecting end 242. For example, second cable channel 392 may comprise one or more channel surface features (e.g., curves, bends, and/or the like) configured to increase surface friction with the portion of second connecting end 242. Increasing surface friction between surfaces of second cable channel 392 and the portion of second connecting end 242 may at least partially aid second cable channel 392 to retain the portion of second connecting end 242.

In various embodiments, cable stretch limiter 380 may comprise an elastic cord 385. Elastic cord 385 may be configured to limit an extension range of coiled portion 245 in the second position. For example, elastic cord 385 may be configured to stretch from a resting position to an extended position. Elastic cord 385 may be in the resting position in response to coiled portion 245 being in the first position. Elastic cord 385 may stretch into the extended position in response to coiled portion 245 translating into the second position. In the extended position, elastic cord 385 may at least partially prevent further extension of coiled portion 245.

In various embodiments, elastic cord 385 may be positioned between first end bracket 381 and second end bracket 382. Elastic cord 385 may be coupled at a first cord end to first end bracket 381 and at a second cord end to second end bracket 382. In response to cable stretch limiter 380 being coupled to connecting cable 240, elastic cord 385 may be positioned through a middle of coiled portion 245. For example, and in some embodiments, cable stretch limiter 380 may be coupled to connecting cable 240 my connecting one of first end bracket 381 or second end bracket 382 to connecting cable 240, guiding and positioning elastic cord 385 through a middle of coiled portion 245, and connecting the other of first end bracket 381 or second end bracket 382 to connecting cable 240.

Elastic cord 385 may comprise any suitable material configured to stretch from a resting position to an extended position. For example, elastic cord 385 may comprise an internal elastomeric material and an outer woven jacket. The outer woven jacket may be configured to stiffen in the extended position to reduce, limit, and/or at least partially prevent further stretching of clastic cord 385.

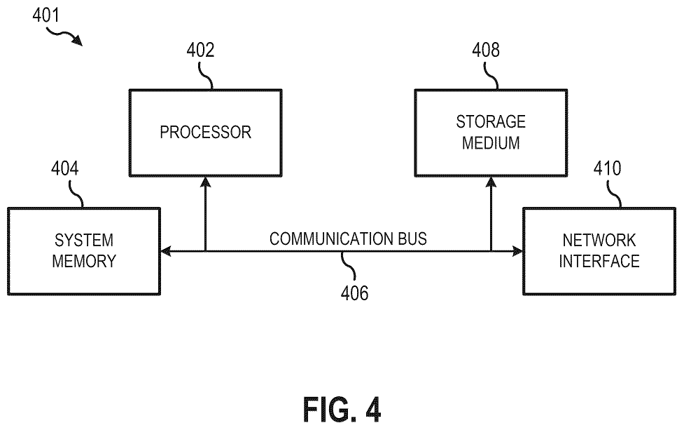

In various embodiments, and with reference to FIG. 4, an exemplary computer-based system 401 is disclosed. Computer-based system 401 may be appropriate for use in accordance with embodiments of the present disclosure. In some embodiments, the accompanying description of computer-based system 401 may be applicable to servers, personal computers, mobile phones, smart phones, tablet computers, embedded computing devices, and other currently available or yet-to-be-developed devices that may be used in accordance with embodiments of the present disclosure. In some embodiments, the accompanying description of computer-based system 401 may be applicable to handles, projectile launchers, and/or the like that may be used in accordance with embodiments of the present disclosure.

Computer-based system 401 may include a processor 402 and a system memory 404 connected by a communication bus 406. Depending on the exact configuration and type of computer-based system, system memory 404 may be volatile or nonvolatile memory, such as read only memory (“ROM”), random access memory (“RAM”), EEPROM, flash memory, or other memory technology. Those of ordinary skill in the art and others will recognize that system memory 404 typically stores data and/or program modules that are immediately accessible to and/or currently being operated on by processor 402. In this regard, processor 402 may serve as a computational center of computer-based system 401 by supporting the execution of instructions. Processor 402 may comprise one or more processing units, as discussed further herein. System memory 404 may comprise one or more memory units, as discussed further herein.

Computer-based system 401 may include a network interface 410 comprising one or more components for communicating with other devices and systems over a network. Embodiments of the present disclosure may access basic services that utilize network interface 410 to perform communications using common network protocols. Network interface 410 may comprise a communications unit, as discussed further herein.

Computer-based system 401 may also include a storage medium 408. However, services may be accessed using a computer-based system that does not include means for persisting data to a local storage medium. Therefore, storage medium 408 depicted in FIG. 4 is optional. Storage medium 408 may be volatile or nonvolatile, removable or nonremovable, and implemented using any technology capable of storing information such as, but not limited to, a hard drive, solid state drive, CD-ROM, DVD, or other disk storage, magnetic tape, magnetic disk storage, and/or the like. Storage medium 408 may include one or more memory units, as discussed further herein.

As used herein, the term “computer-readable medium” includes volatile and nonvolatile and removable and nonremovable media implemented in any method or technology capable of storing information, such as computer-readable instructions, data structures, program modules, or other data. In this regard, system memory 404 and storage medium 408 depicted in FIG. 4 are examples of computer-readable media.

For ease of illustration and because it is not important for an understanding of the claimed subject matter, FIG. 4 does not show some of the typical components of many computer-based systems. In this regard, computer-based system 401 may include input devices, such as a keyboard, keypad, mouse, trackball, microphone, video camera, touchpad, touchscreen, electronic pen, stylus, and/or any other input device described herein. Such input devices may be coupled to computer-based system 401 by wired or wireless connections including RF, infrared, serial, parallel, BLUETOOTH®, USB, or other suitable connection protocols using wireless or physical connections.

In any of the described examples, data can be captured by input devices and transmitted or stored for future processing. The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computer-based system 401 (e.g., a client device), or can be integral components of computer-based system 401. In some embodiments, multiple input devices may be combined into a single, multifunction input device (e.g., a video camera with an integrated microphone).

Computer-based system 401 may also include output devices such as a display, speakers, printer, and/or any other output device described herein. The output devices may include video output devices such as a display or touchscreen. The output devices also may include audio output devices such as external speakers or earphones. The output devices can be separate from and communicatively coupled to computer-based system 401, or can be integral components of computer-based system 401. Input functionality and output functionality may be integrated into the same input/output device (e.g., a touchscreen). Any suitable input device, output device, or combined input/output device either currently known or developed in the future may be used with described systems.

In various embodiments, a “processing unit” as described herein may comprise any suitable hardware and/or software-based processing component. For example, a processing unit may comprise one or more of a processing circuit, a processor, an application specific integrated circuit (ASIC), a controller, a microcontroller, a microprocessor, a programmable logic device, logic circuitry, and/or the like.

In various embodiments, a “communications unit” as described herein may comprise any suitable hardware and/or software components capable of enabling the transmission and/or reception of data. A communications unit may enable electronic communications between devices and systems, such as between a handle and a magazine. A communications unit may enable communications over a network. Examples of a communications unit may include a modem, a network interface (such as an Ethernet card), a transmitter and/or a receiver, a transceiver, a communications port, etc. Data may be transferred via a communications unit in the form of signals which may be electronic, electromagnetic, optical, radio frequency (RF), or other signals capable of being transmitted or received by a communications unit. A communications unit may be configured to communicate via any wired or wireless protocol such as a CAN bus protocol, an Ethernet physical layer protocol (e.g., those using 10BASE-T, 100BASE-T, 1000BASE-T, etc.), an IEEE 1394 interface (e.g., Fire Wire), Integrated Services for Digital Network (ISDN), a digital subscriber line (DSL), an 402.11a/b/g/n/ac signal (e.g., Wi-Fi), a wireless communications protocol using short wavelength UHF radio waves and defined at least in part by IEEE 402.15.1 (e.g., the BLUETOOTH® protocol maintained by Bluetooth Special Interest Group), a wireless communications protocol defined at least in part by IEEE 402.15.4 (e.g., the ZigBee® protocol maintained by the ZigBee alliance), a cellular protocol, an infrared protocol, an optical protocol, an RF protocol, or any other protocol capable of transmitting information via a wired or wireless connection.

Two or more of the system components may be in electronic communication via a network. As used herein, the term “network” may further include any cloud, cloud computing system, or electronic communications system or method that incorporates hardware and/or software components. Communication amongst the devices and systems over a network may be accomplished through any suitable communication channel, such as, for example, a telephone network, an extranet, an intranet, the internet, a wireless communication, local area network (LAN), wide area network (WAN), virtual private network (VPN), and/or the like.

Electronic communications between the systems and devices may be unsecure. A network may be unsecure. Electronic communications disclosed herein may utilize data encryption. Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, Triple DES, Blowfish, AES, MD5, HMAC, IDEA, RC6, and symmetric and asymmetric cryptosystems. Network communications may also incorporate SHA series cryptographic methods, elliptic-curve cryptography (e.g., ECC, ECDH, ECDSA, etc.), and/or other post-quantum cryptography algorithms under development.

For the sake of brevity, conventional data networking, application development, and other functional aspects of system may not be described in detail herein. Furthermore, the connecting lines shown in the various figures contained herein are intended to represent exemplary functional relationships and/or electronic communications between the various elements. It should be noted that many alternative or additional functional relationships or electronic communications may be present in a practical system.

In various embodiments, a “memory” or “memory unit” as discussed herein may comprise any hardware, software, and/or database component capable of storing and maintaining data. For example, a memory unit may comprise a database, data structure, memory component, or the like. A memory unit may comprise any suitable non-transitory memory known in the art, such as, an internal memory (e.g., random access memory (RAM), read-only memory (ROM), solid state drive (SSD), etc.), removable memory (e.g., an SD card, an xD card, a CompactFlash card, etc.), or the like.

Any database discussed herein may include relational, hierarchical, graphical, distributed ledger, blockchain, object-oriented structure, and/or any other database configurations, unless otherwise specified. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Moreover, a database may be organized in any suitable manner, for example, as data tables or lookup tables. Each record stored in a database may be a single file, a series of files, a linked series of data fields, and/or any other data structure or schema.

Any database, system, device, server, or other components of the system described herein may consist of any combination thereof at a single location or at multiple locations. For example, any database described herein may comprise a single database or a plurality of databases (virtual partitions or physically distinct). Each database or system may include any of various suitable security features, such as firewalls, access codes, encryption, decryption, compression, decompression, and/or the like.

In various embodiments, an “input device” as discussed herein may comprise hardware and/or software used to provide data, inputs, control signals, and the like to a computer-based system, software application, etc. For example, an input device may include a pointing device (e.g., mouse, joystick, pointer, etc.), a keyboard (e.g., virtual or physical), a touchpad or touchscreen interface, a video input device (e.g., camera, scanner, multi-camera system, etc.), a virtual reality system, an audio input device (e.g., microphone, digital musical instrument, etc.), a biometric input device (e.g., fingerprint scanner, iris scanner, etc.), a composite device (e.g., a device having a plurality of different forms of input), and/or any other input device.

In various embodiments, an “output device” as discussed herein may comprise hardware and/or software configured to convert information into a human-accessible form, for display, projection, or physical reproduction. For example, an output device may include a display device (e.g., monitor, monochrome display, colored display, CRT, LCD, LED, projector, video card, etc.), an audio output device (e.g., speaker, headphones, sound card, etc.), a location services system (e.g., global positioning system (GPS), etc.), a printer (e.g., dot matrix printer, inkjet printer, laser printer, 3D printer, wide-format printer, etc.), a braille reader, a composite device (e.g., a device having a plurality of different forms of output), and/or any other output device.

In various embodiments, a connecting cable for transmitting electrical power and data between a primary recording device and an auxiliary recording device is disclosed. The connecting cable may comprise a first connecting end opposite a second connecting end. The connecting cable may comprise an optical fiber channel extending from the first connecting end to the second connecting end. The connecting cable may comprise a coiled portion defined between the first connecting end and the second connecting end, wherein the coiled portion may be configured to translate from a first compressed position to a second elongated position.

In various embodiments of the above connecting cable, the coiled portion in the first compressed position may comprise a first length, the coiled portion in the second elongated position may comprise a second length, and the second length may be greater than the first length. The coiled portion may be wound in a clockwise direction. The connecting cable may further comprise an outer elongated core surrounding the optical fiber channel. The coiled portion may be wound in a first direction, and the outer elongated core may be wound in a second direction. The first direction may be different from the second direction. The first direction may comprise a clockwise direction, and the second direction may comprise a counterclockwise direction. The connecting cable may further comprise an outer layer and an outer elongated core disposed radially inward from the outer layer, and the fiber channel may be disposed radially inward from the outer elongated core. The outer elongated core may comprise a plurality of power channels and a plurality of data channels. The plurality of power channels and the plurality of data channels may be wound around the fiber channel.

In various embodiments, a connecting cable for recording devices is disclosed. The connecting cable may comprise an optical fiber channel. The connecting cable may comprise a first winding layer radially outward from the optical fiber channel, wherein the first winding layer may be spirally wound in a first direction. The connecting cable may comprise a second winding layer radially outward from the first winding layer, wherein the second winding layer may be spirally wound in a second direction, and wherein the second direction may be different from the first direction. The connecting cable may comprise a third winding layer radially outward from the second winding layer, wherein the third winding layer may be spirally wound in a third direction.

In various embodiments of the above connecting cable, the third direction may be different from the second direction. The third direction may be the same as the first direction. The first direction may comprise a counterclockwise direction, and the second direction may comprise a clockwise direction. The third direction may comprise the counterclockwise direction. The connecting cable may further comprise a coiled portion defined between a first connecting end and a second connecting end, and the coiled portion may be spirally wound in a fourth direction. The fourth direction may be the same as the second direction. The first direction and the third direction may comprise a counterclockwise direction, and the second direction and the fourth direction may comprise a clockwise direction. The first winding layer, the second winding layer, and the third winding layer may be defined from the first connecting end to the second connecting end. The first winding layer, the second winding layer, and the third winding layer may each comprise a first length, the coiled portion may comprise a second length, and the first length may be greater than the second length. The first winding layer may comprise a data channel and a power channel, the second winding layer may comprise a tape layer, and the third winding layer may comprise a shield layer. Axially adjacent portions of the second winding layer may axially overlap. Axially adjacent portions of the third winding layer may be axially separated by a gap. The optical fiber channel, the first winding layer, the second winding layer, and the third winding layer may be coaxial.

In various embodiments, a cable stretch limiter for a coiled connecting cable is disclosed. The cable stretch limiter may comprise a first end bracket configured to couple to a first connecting end of the coiled connecting cable. The cable stretch limiter may comprise a second end bracket configured to couple to a second connecting end of the coiled connecting cable. The cable stretch limiter may comprise an elastic cord coupled to the first end bracket and the second end bracket, wherein the elastic cord may be configured to stretch from a resting position to an extended position, and wherein in the extended position the elastic cord may be configured to limit further translation of a coiled portion of the connecting cable.

In various embodiments of the above cable stretch limited, the first end bracket and the second end bracket may be symmetrical. The first end bracket may comprise a first cable channel configured to retain the first connecting end of the coiled connecting cable. The first cable channel may comprise a first portion defined and open on a top surface of the first end bracket and a second portion defined and open on a bottom surface of the first end bracket. The first portion and the second portion may comprise a same surface area. The first cable channel may comprise a channel surface feature configured to increase surface friction between the first cable channel and the first connecting end of the coiled connecting cable. The second end bracket may comprise a second cable channel configured to retain the second connecting end of the coiled connecting cable. The second cable channel may comprise a first portion defined and open on a top surface of the second end bracket and a second portion defined and open on a bottom surface of the second end bracket. The first portion and the second portion may comprise a same surface area. The second cable channel may comprise a channel surface feature configured to increase surface friction between the second cable channel and the second connecting end of the coiled connecting cable. The clastic cord may be positioned through a middle of the coiled portion of the connecting cable. The clastic cord may comprise an internal elastomeric material and an outer woven jacket.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A connecting cable for transmitting electrical power and data between a primary recording device and an auxiliary recording device, the connecting cable comprising:
a first connecting end opposite a second connecting end;
an optical fiber channel extending from the first connecting end to the second connecting end; and
a coiled portion defined between the first connecting end and the second connecting end, wherein the coiled portion is configured to translate from a first compressed position to a second elongated position.

2. The connecting cable of claim 1, wherein the coiled portion in the first compressed position comprises a first length, wherein the coiled portion in the second elongated position comprises a second length, and wherein the second length is greater than the first length.

3. The connecting cable of claim 1, wherein the coiled portion is wound in a clockwise direction.

4. The connecting cable of claim 1, further comprising an outer elongated core surrounding the optical fiber channel.

5. The connecting cable of claim 4, wherein the coiled portion is wound in a first direction, and wherein the outer elongated core is wound in a second direction.

6. The connecting cable of claim 5, wherein the first direction is different from the second direction.

7. The connecting cable of claim 5, wherein the first direction comprises a clockwise direction, and wherein the second direction comprises a counterclockwise direction.

8. The connecting cable of claim 1, further comprising:
an outer layer; and
an outer elongated core disposed radially inward from the outer layer, and wherein the fiber channel is disposed radially inward from the outer elongated core.

9. The connecting cable of claim 8, wherein the outer elongated core comprises a plurality of power channels and a plurality of data channels.

10. The connecting cable of claim 9, wherein the plurality of power channels and the plurality of data channels are wound around the optical fiber channel.

11. A recording system comprising:
a primary recording device;
an auxiliary recording device; and
a connecting cable configured to transmit electrical power and data between the primary recording device and the auxiliary recording device, wherein the connecting cable comprises:
a first connecting end opposite a second connecting end, wherein the first connecting end is coupled to the primary recording device, and wherein the second connecting end is coupled to the auxiliary recording device;
an optical fiber channel extending from the first connecting end to the second connecting end; and
a coiled portion defined between the first connecting end and the second connecting end, wherein the coiled portion is configured to translate from a first compressed position to a second elongated position.

12. The recording system of claim 11, wherein the primary recording device is configured to transmit recording instructions to the auxiliary recording device via the connecting cable.

13. The recording system of claim 11, wherein the auxiliary recording device is configured to transmit image data to the primary recording device via the optical fiber channel of the connecting cable.

14. The recording system of claim 11, wherein the auxiliary recording device is configured to receive electrical power from the primary recording device via the connecting cable.

15. The recording system of claim 11, wherein the primary recording device is configured to mount on a first location of a user, wherein the auxiliary recording device is configured to mount on a second location of the user, and wherein the first location is different from the second location.

16. The recording system of claim 15, wherein the connecting cable spans a distance from the first location to the second location.

17. The recording device of claim 11, wherein the primary recording device is configured to capture a first perspective, wherein the auxiliary recording device is configured to capture a second perspective, and wherein the first perspective is different from the second perspective.

18. The recording device of claim 11, wherein the connecting cable further comprises an outer elongated core surrounding the optical fiber channel, wherein the coiled portion is wound in a first direction, and wherein the outer elongated core is wound in a second direction.

19. The recording device of claim 18, wherein the first direction is different from the second direction.

20. The recording device of claim 18, wherein the first direction comprises a clockwise direction, and wherein the second direction comprises a counterclockwise direction.
